(19) United States
(12) Patent Application Publication
(10) Pub. No.: US 2009/0006175 A1
(43) Pub. Date: Jan. 1, 2009

(54) BUSINESS METHODS FOR PROVIDING EMERGENCY PROPERTY REPAIRS AND OTHER PROPERTY-RELATED BENEFITS

(76) Inventor: Richard James Maertz, Laguna Hills, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/769,632

(22) Filed: Jun. 27, 2007

(51) Int. Cl. G06Q 10/00; G06Q 30/00

(52) U.S. Cl. 705/10; 705/1; 705/14

(57) ABSTRACT

Disclosed herein business methods for providing property-related repairs, which, among other things, provide property owners with emergency property-related repairs and other benefits and advantages associated with managing and improving their property. In one exemplary embodiment, the business method involves offering membership in an organization that provides emergency repair services for homes, investment properties or businesses of members, receiving requests for membership from prospective members wanting to become members in the organization, granting membership to those prospective members that requested membership and satisfy certain membership criteria, receiving requests from members for the emergency repair services and providing them with the requested repair services. In alternative embodiments, the business method provides property owners with numerous other incentives, benefits and advantages that are needed by property owners to successfully manage and improve their properties.

### FIELD OF THE DISCLOSURE

The present disclosure relates generally to business methods for providing a variety of property-related services and products. In particular, the present disclosure relates to business methods for providing emergency repairs and property-related services for residential and commercial properties.

### BACKGROUND OF THE DISCLOSURE

The present disclosure relates to an improved business method for providing a variety of business and home related services to property owners and managers. In particular, the present disclosure offers for consideration a new business method of providing repairs and other property-related services, which provide a variety of benefits that overcome drawbacks of the prior art.

More than ever before, changes in various economic factors have allowed a larger percentage of the U.S. population to realize the American dream of owning your own home. As a result, home ownership throughout, the United States is at an all time high. Similarly, over the last five to ten years, record numbers of individuals have purchased investment property, including both commercial and residential income properties. At the same time, the overall U.S. real-estate market has appreciated at a record pace. As a result, property owners often find that their properties represent a significant portion of their net worth and oftentimes are their most valuable asset. Accordingly, property owners, more than ever, want to do everything they can to protect and improve their investments.

Unfortunately, in order to protect and enhance their properties, property owners must deal with myriad service providers to obtain the services and products they need. Typically, the services property owners need include management, repair, maintenance, finance and improvement-related services. Similarly, property owners also need access to various appliances, equipment, and building materials to maintain and improve their properties. Unfortunately, finding quality products and services at a competitive prices is often difficult and very time consuming.

When it comes to investment-properties, property owners can hire one or more property-management companies to assist with management and upkeep of their properties. For a fee, which is typically a percentage of the gross income of the property, property management companies provide basic management-related services, which typically include assisting with basic rental and maintenance of the property. Property-management companies often provide addition services for a fee, including providing non-basic repairs and maintenance, advertising, and improving the property.

Unfortunately, property-management companies generally do not provide management services for small, residential or low income producing properties. As a result, single-family home owners and those who own small or relatively low-income producing properties often cannot retain the services of a property-management company and are forced to handle management of their properties themselves. Additionally, due to the cost of hiring a management company, many property owners cannot afford to hire a management company. As a result, property owners often take on at least part of the responsibility of managing their properties by hiring various individual service providers.

Property-related service providers typically provided services that include, but are not limited to, general repairs and maintenance, leasing, advertising, sales and financing, renovations, gardening and landscaping, remodeling, pool services, electrical and plumbing repair and maintenance, roofing, asphalt and cement related services, cleaning, garbage disposal, appliance and air-conditioning sales and service, painting, pest inspection and eradication, interior and exterior design, gate and fence services, additions, improvements and other property-related services. Accordingly, property owners must find, negotiate and hire these various service providers to obtain the services they need, which is a difficult and time consuming process.

It is often difficult for property owners to objectively evaluate the various service providers. In fact, unless the service provider is referred from a trusted source or the property owner has worked with them before, the property owner usually has little to go by in evaluating the service provider. Accordingly, using traditional methods of hiring service providers can cause the property owner to receive poor service and a below average product from an unethical service provider.

If the property owner cannot find a service provider or the service provider does not do an adequate job, the property owner risks being sued and suffering a substantial economic loss. If the property owner hires a service provider that does not do an adequate job or causes damage to the property, the property owner will probably have to the pay to have another service provider to do the job correctly and correct any damage done by the first service provider. Additionally, the property owner's failure to repair or maintain the property is likely to result in angry tenants bringing suit against the property owner and/or moving out and lost income.

If the property is not properly maintained or repaired because the owner is unable to find an adequate service provider, individuals on or near the property might suffer an injury thereby exposing the property owner to extensive liability. Additionally, if the property owner needs urgent emergency repairs or products outside of normal business hours, it is even more difficult for the property owner to find a suitable provider.

Accordingly, a more efficient and cost effective way of obtaining, quality, reliable property-related repairs and other property-related products and services is needed. The present disclosure provides these and other related benefits and advantages as described below and shown in the attached Figures.

### BRIEF DESCRIPTION OF THE DRAWINGS

The above-mentioned features and objects of the present disclosure will become more apparent with reference to the following description taken in conjunction with the accompanying drawings and in which:

FIG. 1 provides an example of a flowchart showing a business method of providing repairs in accordance with at least one embodiment of the present disclosure.

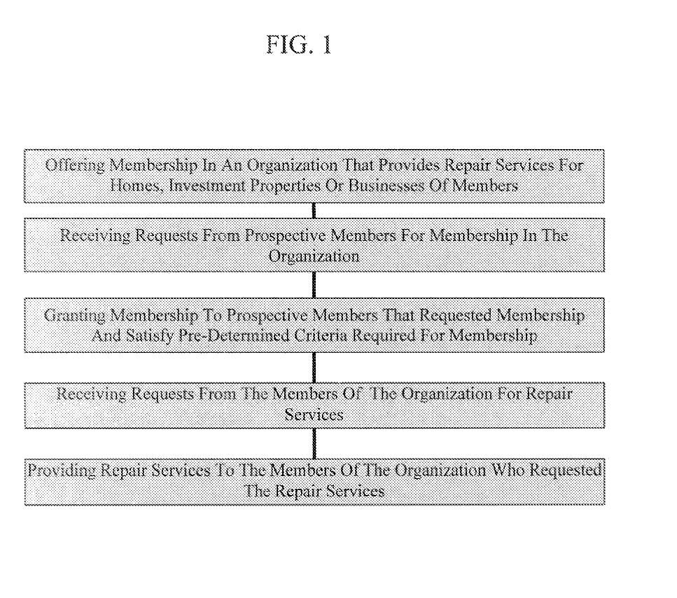

FIG. 2 provides an example of a flowchart showing another business method of providing emergency repairs in accordance with at least one embodiment of the present disclosure.

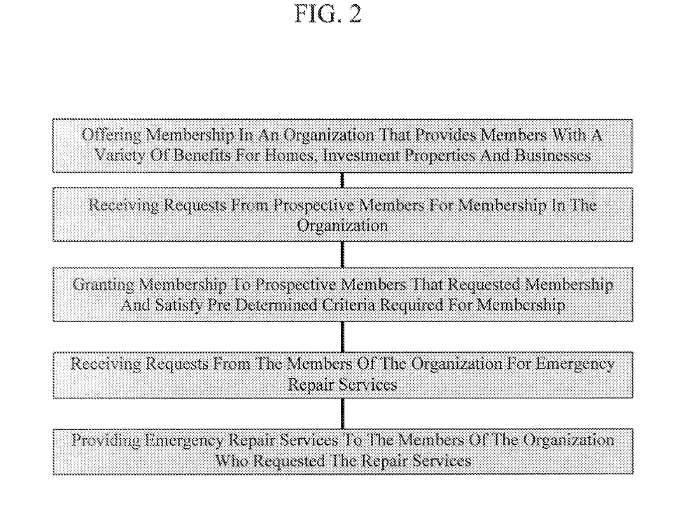

FIG. 3 provides an example of a flowchart showing yet another business method of providing emergency repairs and other property-related benefits in accordance with at least one embodiment of the present disclosure.

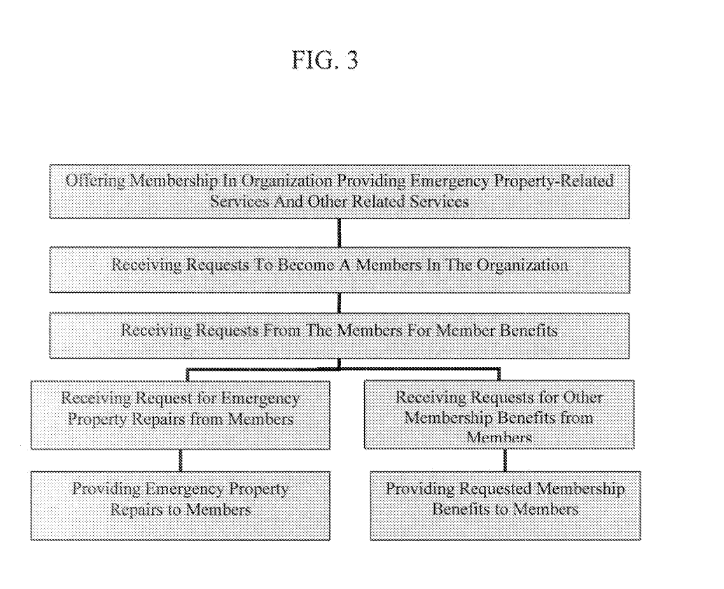

### SUMMARY

Disclosed herein are business methods for providing property-related repairs, including emergency property-related repairs, which provide a cost effective and reliable solution for property owners who need property-related repairs and other incentives, benefits and advantages associated with managing and improving their properties. In one exemplary embodiment, the business method involves 1) offering membership in an organization that provides members with repair services for homes, investment properties or businesses, 2) receiving requests for membership from individuals wanting to become members in the organization that provides those services, 3) granting membership to those individuals that request membership and satisfy certain pre-determined criteria, 4) receiving requests from the members for the repair services, including emergency repair service, and 5) providing the repair services to the members of the organization who requested the repair services. In at least one alternative embodiment, the business method provides property owners with numerous additional incentives, benefits and advantages that are desired by property owners to successfully manage, improve and profit from their properties, including but not limited to discounts, rebates, credits, refunds, coupons, or special offers on property-related products and services.

### DETAILED DESCRIPTION

The present disclosure is directed to business methods for providing property-related services and benefits to property owners. As discussed herein, the methods of the present disclosure provide numerous benefits and advantages over previous methods and also provide additional benefits that should be evident to one of ordinary skill in the art.

Property is often a large portion of an individual's total wealth. As a result, property owners want to protect and enhance their property-related investments. In doing so, property owners hire different service providers to deal with different aspects of managing and improving their properties. In an effort to protect and improve their valuable assets, property owners want a cost effective way to protect themselves from damage caused by unexpected problems and accidents that affect their properties and the income they produce. These unexpected problems and accidents can result in the need for emergency repairs that, if ignored, can result in significant damage to the property and decrease the property owner's net-worth and income. This is especially true because unexpected problems requiring immediate repairs can happen at a time where it is difficult to impossible to find a qualified service-provider to perform the needed repairs.

Property owners are especially at risk if an emergency requiring repairs happens at an odd or inconvenient time (2:00 am on Sunday morning or while the property owner is tied up or on vacation) and the property owner cannot find qualified service provider to make the needed repairs. As a result, property owners are often forced to use someone who is not qualified, trusted or recommended, which can result in the job being done improperly or the property owner being overcharged for the repairs. Alternatively, sometimes the property owner cannot find any qualified service provider to provide the needed repairs, or temporary repairs that prevent additional damage to the property, resulting in damage to the property and financial loss to the property owner. If the property owner could find a reliable and qualified service provider to provide temporary repairs that prevent any further damage, more thorough repairs could be done at a later time. Accordingly, property owners have a need for reliable and cost effective property-related repairs from qualified service providers and a host of additional property-related benefits and advantages. The present disclosure provides these and other related benefits and advantages.

In one embodiment of the present disclosure, a method of providing repairs for homes, investment properties and businesses and other property-related products and services to members of an organization is provided by offering membership in an organization that provides repair services for homes, investment properties or businesses of members. In one aspect of the present disclosure, the organization provides various types of membership plans to individual property owners, corporations and organizations depending on the type, size, quality, number and specific needs of die property or properties that need repair services and property-related products and services.

For example and not by way of limitation, in one aspect of the present disclosure, the organization provides, for a fee, different types and levels of membership designed for individuals or businesses with different needs. For example and not by way of limitation, the organization provides silver, gold, and platinum membership levels. The individual membership would be for individual property owners desiring repair and property-related services for one or two single-family homes. The business membership would be for individuals, corporations or organizations that desire repair services for more than two single-family homes, an apartment building, or commercial property or any combination of these types of properties.

The organization also provides different types and levels of membership that give prospective members a variety of membership options that more closely meet their specific needs. For example and not by way of limitation, the basic or silver membership provides members with twenty-four hour, seven days a week property-related repair services for a relatively low annual membership fee.

The next level up in membership, the plus or gold membership, provides members with repair related services and a whole host of property-related incentives, benefits and advantages that are useful to property owners. More specifically, an example of some of the benefits and advantages of gold membership include providing members with referrals to other pre-qualified providers of property-related products and services and providing members with discounts, rebates, credits, refunds, special offers, or coupons on property-related products and services needed by the property owner. For example and not by way of limitation, members can obtain referrals to pre-qualified maintenance companies that have agreed to provide members with special packages and prices on a variety of property-related services. Another example of a property-related incentives, benefit and advantage that certain memberships would provide is providing members with pre-screened discounts or special offers from companies that sell property-related products (e.g., Home Depot, Ace Hardware, or Lowes).

The premium or platinum membership level provides all the benefits of the gold membership and additionally includes an annual preventative maintenance assessment and some pre-determined preventative maintenance (e.g., minor repairs and adjustments and replacement of air filters) by a pre-approved and pre-qualified service provider. These various types and levels of membership allow prospective members to choose the membership that best meets their needs and budget.

It should be appreciated that the present invention encompasses providing members with any incentive, benefit or advantage that would be desirable to property owners. Accordingly, one of ordinary skill in the art should appreciate that as part of the present invention any incentive, benefit or advantage could be provided to members as part of their membership and that the specific examples provided herein are exemplary and not intended to be limiting in any way.

In another aspect of the present disclosure, the organization pre-screens all service providers that provide repair services to members and eliminates those service providers that do not provide a certain level of quality and value. In yet another aspect of the present disclosure, the organization pre-screen all member incentives, benefits, and advantages and provides members only those incentives, benefits and advantages that provide a certain level of quality and value.

In another aspect of the present invention, each type or level of membership provides a limited number of repair services (e.g., three) per year but members have the option of upgrading or adding on to their membership to provide unlimited property repair services per year.

It should be appreciated that the present invention encompasses different types and levels of membership and various membership incentives, benefits and advantages being offered to the member, all of which will be modified by the organization in accordance with the perceived needs and wants of prospective members. Accordingly, a person of ordinary skill should appreciate that the various aspects of the different membership can be modified to suit the organization or its members.

The organization offers membership in the organization using well known advertising methods, including but not limited to, print and on-line (including the world-wide-web), hand held devices, television, radio and through service and product providers, members, and affiliated organizations associated with the organization. Through advertising, word of mouth and recommendations, the organization will receive membership requests for membership from prospective members. The organization will then determine which of the prospective members requesting membership satisfy their pre-determined membership criteria and grant those individuals or entities membership. In one aspect of the present disclosure, the pre-determined membership criteria could be payment of (or an acknowledgement that the prospective member will pay) the required membership dues. Alternatively, in another aspect of the present disclosure the pre-determined membership criteria includes one or more factors including but not limited to, creditworthiness, owning property of a certain, size, type, quality, location or income producing potential, agreeing to abide by the rules and regulations of the organization, following certain guidelines regarding maintenance and upkeep of the properties, agreeing to use only service or product providers recommended or approved by the organization, agreeing to meet with certain service or product providers or other pre-determined membership criteria that would be beneficial to the organization or its members.

The organization then receives requests from members for one ore more of the benefits of membership, including property-related repair services. Depending on the type of membership the member has, the member might request property-related repair services, other property-related incentives, benefits or advantages or both. Those requests can be received from the members by any known means of communicating a service or product-related request, including but not limited to, an e-mail or electronic text message, a request submitted through an internet website, calling a designated telephone number, or making an in person request at an organization office.

Once the request for one or more member benefits is received from a member, the organization then provides the requested member benefits (e.g., emergency property repairs) to the requesting member. The requested member benefits can be provided by the organization, an affiliate of the organization or a third party that has been qualified or approved by the organization.

In one embodiment of the present disclosure, the only repair services provided by the organization are emergency repair services. For example and not by way of limitation, some of the repairs that would be considered emergency repairs include clogged drains, water overflow, slab plumbing or roof leaks, water heater repairs, missing or damaged tiles or shingles, clogged gutters and drains, gas leaks, pilot-light ignition problems, structural damage caused by foreign objects (e.g., trees), broken windows, enclosing a damaged structure, repairing fences, gates and doors, opening, closing and repairing garage doors and windows, preventing or securing damage from a mud or rock slide, preventing or repairing damage done by snow, clearing driveways and walking areas, opening doors when a member has been locked out and other common emergency repairs services that members need.

In another embodiment of the present disclosure a method of providing emergency repairs for homes, investment properties and businesses and other property-related services to members of an organization is provided by offering membership in an organization, receiving requests to become a member in the organization, receiving requests from the member for the emergency repair services; and providing emergency repair services to those members who requested them.

In another embodiment of the present disclosure, a method of providing emergency repairs for homes, investment properties and businesses and other property-related services to members of an organization is provided by offering membership in an organization that provides members with a variety of benefits for homes, investment properties and businesses, receiving requests to become one of the members in the organization, and receiving requests from members for one or more of the member benefits. Examples of member benefits include but are not limited to: 1) discounts, rebates, credits, refunds or special offers on home, investment property or business appliances, 2) discounts, rebates, credits, refunds or special offers from retailers and wholesalers that offer products and services related to real-property and businesses, 3) discounts, rebates, credits, refunds or special offers from mortgage, insurance and financing companies, 4) free or discounted memberships in other organizations or groups, 5) information regarding maintaining, improving, managing, refinancing or selling homes, investment properties or businesses, 6) referrals to service providers that have been pre-qualified by the organization, 7) discounts, rebates, credits, refunds or special offers on products or services purchased through the organization, 8) discounts, rebates, credits, refunds or special offers for e-commerce purchases of property-related products and services, 9) discounts, rebates, credits, refunds or special offers for maintenance related services, 10) discounts, rebates, credits, refunds or special offers for services and products related to energy efficiency or saving energy, 11) discounts, rebates, credits, refunds or special offers for financial and investment services and products, 12) coupons for property-related products and services, 13) repair services, including twenty four hour a day, seven, days a week emergency repair services, 14) free or discounted home inspection plans and certifications and 15) discounts, rebates, credits, refunds or special offers on real-estate commissions and services. After a member has requested one or more of these member benefits, the organization, either directly or thought another entity, provides one or more of the requested member benefits.

In another aspect of the present disclosure, the emergency repair services are provided by the organization twenty-four hours a day and seven days a week. This feature of at least one embodiment of the present disclosure assures members that their properties will receive needed emergency repairs regardless of when they occur and that they will not suffer harm because they could not find a qualified service provider to provide the needed repairs. Additionally, the property owner will benefit front only having to pay yearly membership dues for these emergency services and not have to waste time and money trying to find the right service provider when the need arises.

In yet another aspect of the present disclosure, the repair services, which could be emergency repair services, are provided by an individual or entity that is licensed, bonded, insured, certified, rated or pre-qualified or authorized by the organization or another entity to perform the specified repairs. It should be appreciated that providing members with service providers that have one or more of these qualifications provides an additional level of security and benefit often not attainable through traditional means of finding a service provider.

In another embodiment of the present disclosure, the emergency repair services provided by the organization are temporary repair services that only prevent damage or additional damage from occurring to the properly or the individuals who work or live at the property. By preventing damage to the property, members are provided with additional time to make an informed decision regarding who to use and how to go about properly repairing or improving their property.

In another aspect of the at least one embodiment of the present disclosure, the organization provides members with access to qualified, pre-approved service providers that can offer members with non-emergency related repairs and property-related improvements. Members can obtain information regarding specific service providers for certain types of projects from the organization (or affiliated) websites and print materials provided by the organization regarding those projects. In yet another aspect of the present disclosure, the specific service providers associated with the organization can provide rebates, discounts, coupons, credits and special offers to members that provide savings that members would not receive if they were to contact the service provider directly. Accordingly, the organization provides members with savings and benefits that they could not obtain without membership in the organization.

In yet another aspect of at least one embodiment of the present disclosure, the organization notifies a member when the repairs to their property are completed. Notification is provided to the member though any know means including, but not limited to, e-mail, telephone or voicemail, web-browsers or internet communication programs, handheld devices or other well-known means of communicating.

In yet another aspect of at least one embodiment of the present disclosure, the organization contacts members after they have received their products or services and requests that they rate the level of service and/or the quality of the work that they received and provide any other comments regarding dealing with the product or service provider or the organization. After doing so, the organization uses the feedback received by members to improve the service and products provided by the organization's providers. In particular, the organization can correct any problems identified by members and, if necessary, eliminate those product or service providers that do not meet the organization's high service and quality standards. This allows the organization to continually critique, update and improve the products and services of the network.

In yet another embodiment of the present disclosure, the organization of group provides members with a variety of additional membership benefits or incentives. For example and not by way of limitation, the organization provides discounts, rebates, credits, refunds or special offers on home, investment property or business appliances. Similarly, the organization provides members with discounts, rebates, credits, refunds or special offers from retailers and wholesalers that offer products and services related to real-property and businesses. These incentives can be provided by large nation retailers (e.g., Home Depot, Ace Hardware, Lowes), small or local providers of appliances or through the organization itself.

In yet another aspect of the present disclosure, the organization also provides members with discounts, rebates, credits, refunds or special offers from mortgage, insurance and financing companies.

In yet another aspect of the present disclosure, the organization also provides members with free or discounted memberships in other organizations or groups.

In yet another aspect of the present disclosure, the organization also provides members with information regarding maintaining, improving, managing, refinancing or selling homes, investment properties or businesses.

In yet another aspect of the present disclosure, the organization also provides members with referrals to non-property related service providers that have been pre-qualified by the organization.

In yet another aspect of the present disclosure, the organization provides discounts, rebates, credits, refunds or special offers on products or services purchased through the organization. This incentive, which can be use with other incentives, benefits or advantages provided by the organization, provides members with an additional reason to purchase products and services through the organization.

In yet another aspect of the present disclosure, the organization provides discounts, rebates, credits, refunds or special offers for e-commerce purchases of property-related products and services. Due to the efficiency and ease of purchasing products and services using e-commerce, members can receive additional incentives for making their e-commerce purchases of property-related products and services through the organization.

In yet another aspect of the present disclosure, the organization provides discounts, rebates, credits, refunds or special offers for maintenance related services. For example and not by way of limitation, the organization can provide incentives on gardening, pool air-conditioning, painting, home security, yard and landscaping care, termite, cleaning, R.O. water, window cleaning, solar heating and energy efficiency, drain and plumbing services and other services related to maintaining or improving a property or business.

In yet another aspect of the present disclosure, the organization provides discounts, rebates, credits, refunds or special offers for financial and investment-related products and services to members.

In yet another aspect of the present disclosure, once the organization provides the member incentives, benefits or advantages discussed throughout this disclosure, the organization receives a request from one of more members for one or more of those incentives, benefits or advantages. The organization then provides the requested member incentives, benefits or advantages to the member, either directly or through another entity.

While the present invention has been described in connection with exemplary embodiments, it will be understood that modifications thereof, within the principals and disclosure outlined above, will be evident to those skilled in the art. Therefore, the present invention is not limited to the disclosed exemplary embodiments but is defined by the claims set forth below.

1. A method of receiving a request for property-related products and services from a members of an organization, comprising:
receiving a first requests code for membership in an organization from a prospective member;
granting membership to the prospective members that satisfy pre-determined criteria required for membership; and
receiving a second request code from the member of the organization for a repair service.

2. The method of claim 1, wherein the repair service provided is an emergency repair service.

3. The method of claim 1, wherein the repair service is provided twenty-four hours a day and seven days a week.

4. The method of claim 1, wherein the emergency repair service is provided by an individual or entity that has at least one of the following attributes:
a. licensed;
b. bonded;
c. insured;
d certified;
e. rated;
pre-qualified; and
g. authorized.

5. The method of claim 1, further comprising:
notifying the member when the repair service is completed; and
requesting the member to provide feedback regarding the completed repair service.

6. The method of claim 1, further comprising:
providing the member with at least one member benefit selected from a group consisting of:
i. discounts, rebates, credits, refunds or special offers on home, investment property or business appliances,
ii. discounts, rebates, credits, refunds or special offers from retailers and wholesalers that offer products and services related to real-property and businesses,
iii. discounts, rebates, credits, refunds or special offers from mortgage, insurance and financing companies,
iv. free or discounted memberships in other organizations or groups,
v. information regarding maintaining, improving, managing, refinancing or selling homes, investment properties or businesses,
vi. referrals to service providers that have been pre-qualifled by the organization,
vii. discounts, rebates, credits, refunds or special offers on products or services purchased through the organization,
viii. discounts, rebates, credits, refunds or special offers for e-commerce purchases of property-related products and services,
ix. discounts, rebates, credits, refunds or special offers for maintenance related services,
x. discounts, rebates, credits, refunds or special offers for services and products related to energy efficiency or saving energy,
xi. discounts, rebates, credits, refunds or special offers for financial and investment services and products,
xii. coupons for property-related products and services,
xiii. discounts, rebates, credits, refunds or special offers for home inspections, and
xiv. discounts, rebates, credits, refunds or special offers on real-estate commissions; and
receiving a third request code from the member for at least one member benefit.

7. (canceled)

8. (canceled)

9. The method of claim 1, further comprising instructing an individual or entity to provide the repair service.

10. A system for interfacing property-related products and services to a member of an organization, the system comprising:
a processor configured to:
receive a first request code for membership in an organization from a prospective member;
grant membership to the prospective member that satisfy pre-determined criteria required for membership; and
receive a second request code from the member of the organization for a repair service.

11. The system of claim 9, wherein the repair service provided is an emergency repair service.

12. The system of claim 9, wherein the processor is further configured to send an instruction to an individual or entity to provide the requested repair service.

13. The system of claim 9, wherein the repair service is provided by an individual or entity that has at least one of the following attributes:
a. licensed;
b. bonded;
c. insured;
d. certified;
e. rated;
f. pre-qualified; and
g. authorized.

14. The system of claim 9, wherein the processor is further configured to:
notify the member when the repair service is completed; and
solicit the member to provide feedback regarding the completed repair service.

15. The system of claim 9, wherein the processor is further configured to:
provide the member with at least one member benefit selected from a group consisting of:
i. discounts, rebates, credits, refunds or special offers on home, investment property or business appliances,
ii. discounts, rebates, credits, refunds or special offers from retailers and wholesalers that offer products and services related to real-property and businesses,
iii. discounts, rebates, credits, refunds or special offers from mortgage, insurance and financing companies,
iv. free or discounted memberships in other organizations or groups,
v. information regarding maintaining, improving, managing, refinancing or selling homes, investment properties or businesses,
vi. referrals to service providers that have been pre-qualifled by the organization,
vii. discounts, rebates, credits, refunds or special offers on products or services purchased through the organization,
vii. discounts, rebates, credits, refunds or special offers for e-commerce purchases of property-related products and services,
ix. discounts, rebates, credits, refunds or special offers for maintenance related services,
x. discounts, rebates, credits, rebinds or special offers for services and products related to energy efficiency or saving energy,
xi. discounts, rebates, credits, refunds or special offers for financial and investment services and products,
xii. coupons for property-related products and services,
xiii. discounts, rebates, credits, refunds or special offers for home inspections, and
xiv. discounts, rebates, credits, refunds or special offers on real-estate commissions; and
receive a third request code from the member for at least one member benefit.

16. A machine-readable medium that provides instructions, which when read by a processor, cause the machine to perform operations comprising:
receiving a first request code for membership in an organization from a prospective member;
granting membership to the prospective members that satisfy pre-determined criteria required for membership; and
receiving a second request code from the member of the organization for a repair service.

17. The machine-readable medium of claim 16, further comprising:
offering membership in the organization that provides repair services for homes, investment properties or businesses of members.

18. The machine-readable medium of claim 16, further comprising:
sending an instruction code to an individual or entity to provide the requested repair service.

19. The machine-readable medium of claim 16, further comprising:
notifying the member when the repair service is completed; and
soliciting the member to provide feedback regarding the completed repair service.

20. The machine-readable medium of claim 16, further comprising:
providing the member with at least one member benefit selected from a group consisting of:
xv. discounts, rebates, credits, refunds or special offers on home, investment property or business appliances,
xvi. discounts, rebates, credits, refunds or special offers from retailers and wholesalers that offer products and services related to real-property and businesses,
xvii. discounts, rebates, credits, refunds or special offers from mortgage, insurance and financing companies,
xviii. free or discounted memberships in other organizations or groups,
xix. information regarding maintaining, improving, managing, refinancing or selling homes, investment properties or businesses,
xx. referrals to service providers that have been pre-qualified by the organization,
xxi. discounts, rebates, credits, refunds or special offers on products or services purchased through the organization,
xxii. discounts, rebates, credits, refunds or special offers for e-commerce purchases of property-related products and services,
xxiii. discounts, rebates, credits, refunds or special offers for maintenance related services,
xxiv. discounts, rebates, credits, refunds or special offers for services and products related to energy efficiency or saving energy,
xxv. discounts, rebates, credits, refunds or special offers for financial and investment services and products,
xxvi. coupons for property-related products and services,
xxvii. discounts, rebates, credits, refunds or special offers for home inspections, and
xxviii. discounts, rebates, credits, refunds or special offers on real-estate commissions; and
receiving a third request code from the member for at least one member benefit.

21. The machine-readable medium of claim 16, wherein the repair service provided is an emergency repair service.

22. The machine-readable medium of claim 16, wherein the repair service is provided by an individual or entity that has at least one of the following attributes:
a. licensed;
b. bonded;
c. insured;
d. certified;
e. rated;
pre-qualifled; and
g. authorized.
